(19) United States
(12) Patent Application Publication
(10) Pub. No.: US 2015/0341657 A1
(43) Pub. Date: Nov. 26, 2015

(54) Encoding and Decoding Method and Devices, and Corresponding Computer Programs and Computer Readable Media

(71) Applicants: Patrice ONNO, Rennes (FR); Guillaume LAROCHE, Melesse (FR); Edouard FRANCOIS, Bourg des Comptes (FR); Christophe GISQUET, Rennes (FR); CANON KABUSHIKI KAISHA, Ohta-ku, Tokyo (JP)

(72) Inventors: Patrice ONNO, Rennes (FR); Guillaume LAROCHE, Melesse (FR); Edouard FRANCOIS, Bourg des Comptes (FR); Christophe GISQUET, Rennes (FR)

(21) Appl. No.: 14/758,948

(22) PCT Filed: Dec. 27, 2013
(86) PCT No.: PCT/EP2013/078091

§ 371 Date: Jul. 1, 2015

(30) Foreign Application Priority Data
Jan. 4, 2013 (GB) 1300147.4

(51) Int. Cl. H04N 19/503; H04N 19/157; H04N 19/187; H04N 19/51

(52) U.S. Cl. CPC H04N 19/503; H04N 19/51; H04N 19/157; H04N 19/187

(57) ABSTRACT

A method for encoding an image comprises the following steps: obtaining intermediate data representative of a base layer of said image encoded in a first compression format, the intermediate data being encoded according to a predefined data format allowing inter layer prediction of an enhancement layer of said image to be encoded in any of a plurality of second compression formats; generating a final bitstream by encoding the enhancement layer according to one of said second compression formats. A corresponding encoding method, as well as encoding and decoding devices, are also described.

“This application claims the benefit under Article 8 PCT of United Kingdom Patent Application No. 1300147.4, filed on Jan. 4, 2013 and entitled “Encoding and decoding methods and devices, and corresponding computer programs and computer readable media”. The above cited patent application is incorporated herein by reference in its entirety”

### FIELD OF THE INVENTION

The invention relates to the field of scalable video coding, in particular scalable video coding applicable to the High Efficiency Video Coding (HEVC) standard. The invention concerns a method, device, computer program, and computer readable medium for encoding and decoding an image comprising blocks of pixels, said image being comprised e.g. in a digital video sequence.

### BACKGROUND OF THE INVENTION

Video coding is a way of transforming a series of video images into a compact bitstream so that the video images can be transmitted or stored. An encoding device is used to code the video images, with an associated decoding device being available to reconstruct the bitstream for display and viewing. A general aim is to form the bitstream so as to be of smaller size than the original video information. This advantageously reduces the capacity required of a transfer network, or storage device, to transmit or store the coded bitstream.

Common standardized approaches have been adopted for the format and method of the coding process, especially with respect to the decoding part. One of the more recent agreements is Scalable Video Coding (SVC) wherein the video image is split into smaller sections (called macroblocks or blocks) and treated as being comprised of hierarchical layers.

The hierarchical layers include a base layer and one or more enhancement layers (also known as refinement layers). SVC is the scalable extension of the H.264/AVC video compression standard. A further video standard being standardized is HEVC, wherein the macro-blocks are replaced by so-called Coding Units and are partitioned and adjusted according to the characteristics of the original image segment under consideration.

Images or frames of a video sequence may be processed by coding each smaller section (e.g. Coding Unit) of each image individually, in a manner resembling the digital coding of still images or pictures. Alternative models allow for prediction of the features in one frame, either from a neighbouring portion, or by association with a similar portion in a neighbouring frame, or from a lower layer to an upper layer (called “inter-layer prediction”). This allows use of already available coded information, thereby reducing the amount of coding bit-rate needed overall.

Differences between the source area and the area used for prediction are captured in a residual set of values which themselves are encoded in association with code for the source area. Effective coding chooses the best model to provide image quality upon decoding, while taking account of the bitstream size that each model requires to represent an image in the bitstream. A trade-off between the decoded picture quality and reduction in required number of bits or bit rate, also known as compression of the data, will typically be considered.

As mentioned above, the invention participates in the design of the scalable extension of HEVC (spatial and quality scalability). HEVC scalable extension will allow coding/decoding a video made of multiple scalability layers. These layers comprise a base layer that is compliant with standards such as HEVC, H.264/AVC or MPEG2, and one or more enhancement layers, coded according to the future scalable extension of HEVC.

It is known that to ensure good scalable compression efficiency, it is advantageous to exploit redundancy that lies between the base layer and the enhancement layer, through so-called inter-layer prediction techniques (shortly presented above).

At the encoder side, a base layer is first built from an input video. Then one or more enhancement layers are constructed in conjunction with the base layer. Usually, the reconstruction step comprises:
upsampling the base layer, and
deriving the prediction information from the base layer to get the prediction information for the enhancement layers.

The base layer is typically divided into Largest Coding Units, themselves divided into Coding Units. The segmentation of the Largest Coding Units is performed according to a well-known quad-tree representation. According to this representation, each Largest Coding Unit may be split into a number of Coding Units, e.g. one, four, or more Coding Units, the maximum splitting level (or depth) being predefined.

Each Coding Unit may itself be segmented into one or more Prediction Units, according to different pre-defined patterns. Prediction information is associated to each Prediction Unit. The pattern associated to the Prediction Unit influences the value of the corresponding prediction information.

To derive the enhancement layer's prediction information, the Prediction Units of the base layer can be up-sampled. For instance, one known technique is to reproduce the Prediction Unit's pattern used for the base layer at the enhancement layer. The prediction information associated to the base layer's Prediction Units is up-sampled in the same way, according to the pattern used.

FIG. 2 shows a low-delay temporal coding structure 20. In this configuration, an input image frame is predicted from several already coded frames. In this particular example, only forward temporal prediction, as indicated by arrows 21, is allowed, which ensures the low delay property. The low delay property means that on the decoder side, the decoder is able to display a decoded picture straight away once this picture is in a decoded format, as represented by arrow 22. In FIG. 2, the input video sequence is shown as comprised of a base layer 23 and an enhancement layer 24, which are each further comprised of a first image frame I and subsequent image frames B.

In addition to temporal prediction, inter-layer prediction between the base 23 and enhancement layer 24 is also illustrated in FIG. 2 and referenced by arrows, including arrow 25. Indeed, the scalable video coding of the enhancement layer 24 aims at exploiting the redundancy that exists between the coded base layer 23 and the enhancement layer 24, in order to provide good coding efficiency in the enhancement layer 24.

In particular, the motion information contained in the base layer can be advantageously used in order to predict motion information in the enhancement layer. In this way, the efficiency of the predictive motion vector coding in the enhancement layer can be improved, compared to non-scalable motion vector coding, as specified in the HEVC video compression system for instance. More generally, inter-layer prediction of the prediction information, which includes motion information, based on the prediction information contained in the coded base layer can be used to efficiently encode an enhancement layer, on top of the base layer.

In the case of spatial scalability, the inter-layer prediction implies that prediction information taken from the base layer should undergo spatial up-sampling. A method to efficiently up-sample HEVC prediction information, in particular in the case of non-dyadic spatial scalability, is given more in detail below.

FIG. 3 schematically illustrates a random access temporal coding structure that may be used in embodiments of the invention. The input sequence is broken down into groups of images (pictures) GOP in a base layer and an enhancement layer. A random access property signifies that several access points are enabled in the compressed video stream, i.e. the decoder can start decoding the sequence at any image in the sequence which is not necessarily the first image in the sequence. This takes the form of periodic INTRA image coding in the stream as illustrated by FIG. 3.

In addition to INTRA images, the random access coding structure enables INTER prediction, both forward and backward (in relation to the display order as represented by arrow 32) predictions can be effected. This is achieved by the use of B images, as illustrated. The random access configuration also provides temporal scalability features, which takes the form of the hierarchical organization of B images, B0 to B3 as illustrated, as shown in the figure.

It can be seen that, in the embodiment shown in FIG. 3, the temporal codec structure used in the enhancement layer is identical to that of the base layer, corresponding to the Random Access HEVC testing conditions so far employed.

In the proposed scalable HEVC codec, use is also made of INTRA enhancement images. In particular, this involves the base picture up-sampling and the texture coding/decoding process.

FIG. 4 illustrates an exemplary encoder architecture 400, which includes a spatial up-sampling step applied on prediction information contained in the base layer, as is possibly used by the invention. The diagram of FIG. 4 illustrates the base layer coding, and the enhancement layer coding process for a given picture of a scalable video.

The first stage of the process corresponds to the processing of the base layer, and is illustrated on the bottom part of the figure under reference 400A.

First, the input picture to be encoded 410 is down-sampled 4A to the spatial resolution of the base layer, to produce a raw base layer 420. Then this raw base layer 420 is encoded 4B in an HEVC compliant way, which leads to the “encoded base layer” 430 and associated base layer bitstream 440. In the next step, some information is extracted from the coded base layer that will be useful afterwards in the inter-layer prediction of the enhancement picture. The extracted information comprises at least:
the reconstructed (decoded) base picture 450 which is later used for inter-layer texture prediction.
the base prediction/motion information 470 of the base picture which is used in several inter-layer prediction tools in the enhancement picture. It comprises, among others, coding unit information, prediction unit partitioning information, prediction modes, motion vectors, reference picture indices, etc.

Once this information has been extracted from the coded base picture, it undergoes an up-sampling process, which aims at adapting this information to the spatial resolution of the enhancement layer. The up-sampling of the extracted base information is performed as described below, for the two types of data listed above: the reconstructed base picture 450 is up-sampled to the spatial resolution of the enhancement layer as up-sampled decoded base layer 480A, for instance by means of an interpolation filter corresponding to the DCTIF 8-tap filter (or any other interpolation filter) used for motion compensation in HEVC. The base prediction/motion information 470 is also transformed (up-scaled), so as to obtain a coding unit representation that is adapted to the spatial resolution of the enhancement layer 480B. A possible prediction information up-sampling mechanism is presented below.

It may be noted that, in step 450 just mentioned, the residual data from the base layer is used to predict the block of the enhancement layer.

Once the information extracted from the base layer is available in its up-sampled form, then the encoder is ready to predict the enhancement picture 4C. The prediction process used in the enhancement layer is executed in an identical way on the encoder side and on the decoder side.

The prediction process consists in selecting the enhancement picture organization in a rate distortion optimal way in terms of coding unit (CU) representation, prediction unit (PU) partitioning and prediction mode selection. These concepts of CU, PU are further defined below in connection with FIG. 5, and are also part of the current version of the HEVC standard.

As now presented, several inter-layer prediction modes are possible for a given Coding Unit for the enhancement layer that are evaluated under a rate distortion criterion. They correspond to the main inter-layer prediction modes found in the literature. However any other alternatives or improvements of these prediction modes are possible.

The “Intra Base Layer” mode (Intra_BL) corresponds to predict the current block of the enhancement layer by applying an up-sampling of the collocated reconstructed base layer block. This mode can be summarized by the following relation:

PRE_{EL}=UPS{REC_{BL}}

where PRE_{EL} is the prediction signal for the current CU in the enhancement layer, UPS{.} is the up-sampling operator (typically a DCT-IF or a Bilinear filter) and REC_{BL} is the reconstructed signal in the collocated CU in the base layer.

The “GRILP” mode, described e.g. in “Description of the scalable video coding technology proposal by Canon Research Centre France”, Joint Collaborative Team on Video Coding (JCT-VC) of ITU-T SG16 WP3 and ISO/IEC JTC1/SC29/WG11, JCTVC-K0041, consists in performing a motion compensation in the enhancement layer and add a corrective value corresponding to the difference between the up-sampling of the reconstructed base layer block and the up-sampling version of the compensated CU in the base layer using the enhancement motion vector.

PRE_{EL}=MC{REF_{EL},MV_{EL}}+UPS{REC_{BL}}−MC{UPS{REF_{BL}},MV_{EL}}

where MC{I, MV} corresponds to the motion compensation operator with motion vector field MV and using as reference picture the picture I.

The “Base” mode consists in predicting the current CU in the enhancement layer by applying a motion compensation using the motion information (motion vector, reference list, reference index, etc.) of the collocated base layer CU. Motion vectors are scaled to match the spatial resolution change. In this mode, we are also considering the addition of the residual data of the base layer for the prediction. This mode can be summarized by the following formula:

PRE_{EL}=MC{REF_{EL},SP_ratio*MV_{BL}}+UPS{RES_{BL}},

where SP_ratio is the spatial ratio between the base layer and the enhancement layer and RES_{BL} is the decoded residual of the corresponding CU in the base layer.

This mode could be also modified to introduce a further step where the predicted CU is smoothed with a deblocking filter (DBF{.}).

PRE_{EL}=DBF{MC{REF_{EL},SP_ratio*MV_{BL}}+UPS{RES_{BL}}},

The second term of the “Base” mode could be also computed in a different manner to introduce a residual prediction as for the “GRILP” mode. The corresponding relation is then the following one:

PRE_{EL}=MC{REF_{EL},SP_ratio*MV_{BL}}+{UPS{REC_{BL}}−MC{UPS{REF_{BL}},MV_{EL}}}.

Alternatively, different methods can be applied for the prediction mode of the current Coding Unit by using differential picture domain. In that case, the prediction mode can be the following ones.

In the “Intra Diff” mode, the prediction signal for the current CU in the enhancement layer is determined as follows:

PRE_{EL}=UPS{REC_{BL}}+PRED_{INTRA}{DIFF_{EL}}

where PRED_{INTRA} {.} is the prediction operator and DIFF_{EL} is the differential domain of the current CU. The prediction operator can use the information from the base layer. Typically, it is interesting to get the Intra mode used for the base layer if available for better compression efficiency. If the base layer is using HEVC or H264 intra mode, the enhancement layer can use the Intra mode of the base layer for prediction in the scalable enhancement layer.

According to the “Inter Diff” mode, described for instance in “Description of low complexity scalable video coding technology proposal by Vidyo and Samsung”, Joint Collaborative Team on Video Coding (JCT-VC) of ITU-T SG16 WP3 and ISO/IEC JTC1/SC29/WG11, JCTVC-K0045, the prediction signal for the current CU in the enhancement layer is determined as follows:

PRE_{EL}=UPS{REC_{BL}}+MC{DIFF_{EL},MV_{EL}},

PRE_{EL}=UPS{REC_{BL}}+MC{REF_{EL}−UPS{REF_{BL}},MV_{EL}}.

As already mentioned above, during the encoding of a particular CU in the enhancement layer, all the possible modes for a CU are tested to evaluate the best coding prediction mode with respect to a rate/distortion criterion.

The possible modes may be split in two categories:
intra-layer modes which correspond to modes applied in a non-scalable video codec. In HEVC for instance, they correspond to the typical “skip”, “intra”, “inter” modes and other possible alternatives.
inter-layer modes which correspond to those that have just been described.

Depending on the result of the encoding process, a coding mode in one of the two categories mentioned above is associated to each CU of the enhancement layer. The chosen mode is signaled in the bitstream for each CU by using a binary code word designed so that the most frequent modes are represented by shortest binary code words.

Referring again to FIG. 4, the prediction process 4C attempts to construct a whole prediction picture 491 for the current enhancement picture to be encoded on a CU basis. To do so, it determines the best rate distortion trade-off between the quality of that prediction picture and the rate cost of the prediction information to encode. The outputs of this prediction process are the following ones:
a set of coding units with associated size, which covers the whole prediction picture;
for each coding unit, a partitioning of this coding unit into one or several prediction units. Each prediction unit is selected among all the prediction unit shapes allowed by the HEVC standard, which are illustrated in the bottom of FIG. 5.
for each prediction unit, a prediction mode decided for that prediction unit, together with the prediction parameters associated with that prediction unit.

Therefore, for each candidate coding unit (CU) in the enhancement picture, the prediction process of FIG. 4 determines the best prediction unit partitioning and prediction unit parameters for that CU based on the information from the base and the enhancement layer.

In particular, for a given prediction unit partitioning of the CU, the prediction process searches the best prediction type for that prediction unit. In HEVC, each prediction unit is given the INTRA or INTER prediction mode. For each mode, prediction parameters are determined.

INTER prediction mode consists in the motion compensated temporal prediction of the prediction unit. This uses two lists of past and future reference pictures depending on the temporal coding structure used (see FIG. 7 and FIG. 8). This temporal prediction process as specified by HEVC is re-used here. This corresponds to the prediction mode called “HEVC temporal predictor” 490 on FIG. 4. Note that in the temporal predictor search, the prediction process searches the best one or two (respectively for uni- and bi-directional prediction) reference blocks to predict a current prediction unit of current picture. This prediction can use the motion information (motion vectors, Prediction Unit partition, Reference list, Reference picture, etc. . . . ) of the base layer to determine the best predictor.

INTRA prediction in HEVC consists in predicting a prediction unit with the help of neighboring prediction units of current prediction unit that are already coded and reconstructed. In addition to the spatial prediction process proposed by HEVC, another INTRA prediction type can be used, called “Intra BL”. The Intra BL prediction type consists of predicting a prediction unit of the enhancement picture with the spatially corresponding block in the up-sampled decoded base picture. It may be noted here that the “Intra BL” prediction mode tries to exploit the redundancy that exists between the underlying base picture and current enhancement picture. It corresponds to so-called inter-layer prediction tools that can be added to the HEVC coding system, in the coding of an enhancement layer.

The “rate distortion optimal mode decision” shown in FIG. 4 results in the following elements:
a set of coding unit representations with associated prediction information for the current picture. This is referred to as prediction information 492 in FIG. 4. All this information then undergoes a prediction information coding step, so that it constitutes a part of the coded video bit stream. It may be noted that, in this prediction information coding, the inter-layer prediction mode, i.e. Intra BL, is signaled as a particular INTRA prediction mode. According to another possible embodiment, the “Intra BL” prediction picture of FIG. 4 can be inserted into the list of reference pictures used in the temporal prediction of current enhancement picture.
a block 491, which represents the final prediction picture of the current enhancement picture to be encoded. This picture is then used to determine and encode the texture data part of current enhancement picture.

The next encoding step illustrated in FIG. 4 consists in computing the difference 493 between the original block 410 and the obtained prediction block 491. This difference comprises the residual data of current enhancement picture 494, which is then processed by the texture coding process 4D (for example comprising a DCT transform following by a quantization of the DCT coefficients and entropy coding). This process provides encoded quantized DCT coefficients 495 which comprise enhancement coded texture 496 for output. A further available output is the enhancement coded prediction information 498 generated from the prediction information 492.

Moreover, the encoded quantized DCT coefficients 495 undergo a reconstruction process (which includes for instance decoding the encoded coefficients, adding the decoded values to the predicted block and filtering, as to be done at the decoder end as explained in detail below), and are then stored as a decoded reference block 499 which is used afterwards in the motion estimation information used in the computation of the prediction mode called “HEVC temporal predictor” 490.

FIG. 5 depicts the coding unit and prediction unit concepts specified in the HEVC standard.

An HEVC coded picture is made of a series of coding units. A coding unit of an HEVC picture corresponds to a square block of that picture, and can have a size in a pixel range from 8×8 to 64×64. A coding unit which has the highest size authorized for the considered picture is also called a Largest Coding Unit (LCU) 510. For each coding unit of the enhancement picture, the encoder decides how to partition it into one or several prediction units (PU) 520. Each prediction unit can have a square or rectangular shape and is given a prediction mode (INTRA or INTER) and some prediction information.

With respect to INTRA prediction, the associated prediction parameters consist in the angular direction used in the spatial prediction of the considered prediction unit, associated with corresponding spatial residual data. In case of INTER prediction, the prediction information comprises the reference picture indices and the motion vector(s) used to predict the considered prediction unit, and the associated temporal residual texture data. Illustrations 5A to 5H show some of the possible arrangements of Partition Units which are available.

FIG. 6 depicts a possible architecture for a scalable video decoder 160. This decoder architecture performs the reciprocal process of the encoding process of FIG. 4. The inputs to the decoder illustrated in FIG. 6 are:
the coded base layer bit-stream 601, and
the coded enhancement layer bit-stream 602.

The first stage of the decoding process corresponds to the decoding 6A of the base layer encoded base block 610. This decoding is then followed by the preparation of all data useful for the inter-layer prediction of the enhancement layer 6B. The data extracted from the base layer decoding step is of two types:
the decoded base picture 611 undergoes a spatial up-sampling step 6C, in order to form the “Intra BL” prediction picture 612. The up-sampling process 6C used here is identical to that of the encoder (FIG. 4);
the prediction information contained in the base layer (base motion information 613) is extracted and re-sampled 6D towards the spatial resolution of the enhancement layer. The prediction information up-sampling process is the same as that used on the encoder side.

When an INTER mode is used for the current CU in the base layer, the residual data of the base layer is also decoded in step 611 and up-sampled in step 612 to provide the final predictive CU in step 650.

Next, the processing of the enhancement layer 6B is effected as illustrated in the upper part of FIG. 6. This begins with the entropy decoding 6F of the prediction information contained in the enhancement layer bit stream to provide decoded prediction information 630. This, in particular, provides the coding unit organization of the enhancement picture, as well as their partitioning into prediction units, and the prediction mode (coding modes 631) associated to each prediction unit. In particular, the prediction information decoded in the enhancement layer may consist in some refinements of the prediction information issued from the up-sampling step 614. In that case, the reconstruction of the prediction information 630 in the enhancement layer makes use of the up-sampled base layer prediction information 614.

Once the prediction mode of each prediction unit of the enhancement picture is obtained, the decoder 600 is able to construct the successive prediction blocks 650 that were used in the encoding of the current enhancement picture. The next decoder steps then consist in decoding 6G the texture data (encoded DCT coefficients 632) associated to current enhancement picture. This texture decoding process follows the reverse process regarding the encoding method in FIG. 4 and produces decoded residual 633.

Once the residual block 633 is obtained from the texture decoding process, it is added 6H to the prediction block 650 previously constructed. This, applied on each enhancement picture's block, leads to the decoded current enhancement picture 635 which, optionally, undergoes some in-loop post-filtering process 6I. Such processing may comprise a HEVC deblocking filter, Sample Adaptive Offset (specified by HEVC) and/or Adaptive Loop Filtering (also described during the HEVC standardization process).

The decoded picture 660 is ready for display and the individual frames can each be stored as a decoded reference block 661, which may be useful for motion compensation 6J in association with the HEVC temporal predictor 670, as applied for subsequent frames.

FIG. 7 depicts a possible prediction information up-sampling process (previously mentioned as step 6C in FIG. 6 for instance). The prediction information up-sampling step is a useful mean to perform inter-layer prediction.

In FIG. 7A, reference 710 illustrates a part of the base layer picture. In particular, the Coding Unit representation that has been used to encode the base picture is illustrated, for the two first LCUs (Largest Coding Unit) of the picture 711 and 712. The LCUs have a height and width, represented by arrows 713 and 714, respectively, and an identification number 715, here shown running from zero to two.

The Coding Unit quad-tree representation of the second LCU 712 is illustrated, as well as prediction unit (PU) partitions e.g. partition 716. Moreover, the motion vector associated to each prediction unit, e.g. vector 717 associated with prediction unit 716, is shown.

In FIG. 7B the organization of LCUs, coding units and prediction units in the enhancement layer 750 is shown, that corresponds to the base layer organization 710. Hence the result of the prediction information up-sampling process can be seen. In this figure, the LCU size (height and width indicated by arrows 751 and 752, respectively) is the same in the enhancement picture and in the base picture, i.e. the base picture LCU has been magnified. As can be seen, the up-sampled version of base LCU 712 results in the enhancement LCUs 2, 3, 6 and 7 (references 753, 754, 755 and 756, respectively). The individual prediction units exist in a scaling relationship known as a quad-tree. Note that the coding unit quad-tree structure of coding unit 712 has been re-sampled in 750 as a function of the scaling ratio (here the value is 2) that exists between the enhancement picture and the base picture. The prediction unit partitioning is of the same type (i.e. the corresponding prediction units have the same shape) in the enhancement layer and in the base layer. Finally, motion vector coordinates e.g. 757 have been re-scaled as a function of the spatial ratio between the two layers.

In other words, three main steps are involved in the prediction information up-sampling process:
The coding unit quad-tree representation is first up-sampled. To do so, a depth parameter of the base coding unit is decreased by one in the enhancement layer.
The coding unit partitioning mode is kept the same in the enhancement layer, compared to the base layer. This leads to prediction units with an up-scaled size in the enhancement layer.
The motion vector is re-sampled to the enhancement layer resolution, simply by multiplying associated x- and y-coordinates by the appropriate scaling ratio (here, this ratio is 2).

As a result of the prediction information up-sampling process, some prediction information is available on the encoder and on the decoder side, and can be used in various inter-layer prediction mechanisms in the enhancement layer, as mentioned above.

In possible scalable encoder and decoder architectures, this up-scaled prediction information may be used for the inter-layer prediction of motion vectors in the coding of the enhancement picture. Therefore one additional predictor is used in this situation compared to HEVC, in the predictive coding of motion vectors.

In the case of spatial scalability with ratio 1.5, the block-to-block correspondence between the base picture and the enhancement picture highly differs from the dyadic case. Therefore, a straight-forward prediction information up-scaling method as that illustrated by FIG. 7 does not seem feasible in the case of ratio 1.5, because it would make it very complicated to determine the right CU splitting for each LCU in the enhancement picture represented by the dashed line in the right part of the above illustration.

FIG. 8 schematically illustrates a process to simplify the motion information inheriting by performing a remapping of the existing motion information in the base layer. Base layer elements are represented by “80x” labels. They are scaled at the enhancement layer resolution to better understand the spatial relationship between the structure of the enhancement layer and the base layer. The enhancement layer is represented by “81x” labels.

The interlayer derivation process consists in splitting each LCU 810 in the enhancement picture into CUs with minimum size (4×4 or 8×8). Then, each CU is associated to a single Prediction Unit (PU) 811 of type 2N×2N. Finally, the prediction information of each Prediction Unit is computed as a function of prediction information associated to the co-located area in the base picture.

The prediction information derived from the base picture includes the following information from the base layer. Typically for a CU represented by the block 811 in FIG. 8, the following information is derived from the PU 801 of the base layer:

1. Prediction mode,

2. Merge information,

3. Infra prediction direction (if relevant),

4. Inter direction,

5. Coded Block Flag (CBF) values, indicating whether there is coded residue to add to the prediction for a given block,

6. Partitioning information,

7. CU size,

8. Motion vector prediction information,

9. Reference picture indices,

10. QP value (used afterwards if a deblocking onto the Base Mode prediction picture),

11. Motion vector values (note the motion field is inherited before the motion compression that takes place in the base layer and are scaled by 1.5).

It is important to note that, for the current example, the derivation is performed with the CU of the base layer which corresponds to the bottom right pixel of the center of the current CU. It is important to note that another position or selection could be done to select the above inter layer information.

According to this process, each LCU 810 of the enhancement picture is organized in a regular CU splitting according to the corresponding LCU in the base picture 800 which was represented by a quad-tree structure.

In the above part, a typical scalable codec that embed the base layer bitstream and the enhancement layer bitstream in a single bitstream has been described with reference to FIGS. 2 to 8. The main drawback of such a codec is that the base layer and the enhancement layer must be built at the same time and there is no alternative to use another format for the base layer than those combining the two sub-bitstreams in a single bitstream.

### SUMMARY OF THE INVENTION

In this context, the invention provides a method for encoding an image comprising the following steps:
obtaining intermediate data representative of a base layer of said image encoded in a first compression format, the intermediate data being encoded according to a predefined data format allowing inter layer prediction of an enhancement layer of said image to be encoded in any of a plurality of second compression formats;
generating a final bitstream by encoding the enhancement layer according to one of said second compression formats.

Thus, an enhancement layer can be produced based on said intermediate data, which represents the base layer but may involve some modifications compared to the base layer, and this solution is consequently particularly flexible.

The final bitstream may possibly include, depending on a selection criterion, data of the base layer or said intermediate data.

Thus, depending on the selection criterion, which may involve for instance choices made a the decoder's end or a data size criterion, data of the base layer can be sent in the final bitstream or separately therefrom, or may simply be represented by said intermediate data.

According to a possible embodiment, data of the enhancement layer may be determined by:
determining a predicted enhancement image based on said intermediate data;
subtracting the predicted enhancement image from a raw version of the image to obtain residual data;
encoding the residual data.

According to possible embodiments described below, the intermediate data may be obtained from base layer data either through a refinement process, through a filtering process or through a summarization process.

The summarization process involves for instance a reduction of a motion vector number per block of pixels in the image and/or a reduction in accuracy of motion vector values and/or a reduction of a reference image list number and/or a reduction of a number of reference images per reference image list.

It is also proposed to use a step of generating an identifier descriptive of said predefined data format. This identifier may be transmitted to the decoder so that the decoder has the ability to use the intermediate data in said predefined data format for inter layer prediction (without needing any prior knowledge of the predefined format), as further explained below.

The identifier may be included in a parameter set or in a slice header.

As further explained below, the identifier may include a syntax element representative of the codec used in said predefined data format and/or a profile identifier defining at least one tool used said predefined data format, and/or an element indicative of a process applied to data of the base layer to obtain the intermediate data.

The invention also provides a method for decoding an image comprising the followings steps:
receiving a final bitstream comprising an enhancement layer encoded in one of a plurality of second compression formats (and possibly including data of a base layer);
receiving an identifier descriptive of a predefined format;
obtaining intermediate data representative of a base layer of said image encoded in a first compression format, the intermediate data being encoded according to said predefined data format allowing inter layer prediction of an enhancement layer of said image in any of said plurality of second compression formats.

Thanks to the identifier descriptive of the predefined format, the decoder may configure in such a manner to be adapted to use the intermediate data for inter layer prediction, e.g. when reconstructing the image using the enhancement layer.

In this respect, the decoding method may include a step of reconstructing said image by:
determining a predicted enhancement image based on said intermediate data;
decoding data of the enhancement layer to obtain residual data;
combining the predicted enhancement image and the residual data to obtain the reconstructed image.

The invention further provides a device for encoding an image comprising:
a module configured to obtain intermediate data representative of a base layer of said image encoded in a first compression format, the intermediate data being encoded according to a predefined data format allowing inter layer prediction of an enhancement layer of said image to be encoded in any of a plurality of second compression formats;
a module configured to generate a final bitstream by encoding the enhancement layer according to one of said second compression formats.

The invention also provides a device for decoding an image comprising:
a module configured to receive a final bitstream, comprising an enhancement layer encoded in one of a plurality of second compression formats, and an identifier descriptive of a predefined format;
a module configured to obtain intermediate data representative of a base layer of said image encoded in a first compression format, the intermediate data being encoded according to said predefined data format allowing inter layer prediction of an enhancement layer of said image in any of said plurality of second compression formats.

Optional features presented above with respect to the encoding method are also applicable to the decoding method, to the encoding device and to the decoding device just mentioned.

The invention also proposes a computer program, adapted to be loaded in a device, which, when executed by a microprocessor or computer system in the device, causes the device to perform the steps of the decoding or encoding method described above.

The invention also proposed a non-transitory computer-readable medium storing a program which, when executed by a microprocessor or computer system in a device, causes the device to perform the steps of the decoding or encoding method described above.

The invention further provides an encoding device substantially as herein described with reference to, and as shown in, FIG. 9 of the accompanying drawings, as well as a decoding device substantially as herein described with reference to, and as shown in, FIG. 10 of the accompanying drawings.

### BRIEF DESCRIPTION OF THE DRAWINGS

Other particularities and advantages of the invention will also emerge from the following description, illustrated by the accompanying drawings, in which:

FIG. 1 illustrates an example of a device for encoding or decoding images;

FIG. 2 schematically illustrates a possible low-delay temporal coding structure;

FIG. 3 schematically illustrates a possible random access temporal coding structure;

FIG. 4 illustrates an exemplary encoder architecture;

FIG. 5 depicts the coding unit and prediction unit concepts specified in the HEVC standard

FIG. 6 depicts a possible architecture for a scalable video decoder;

FIG. 7 depicts a possible prediction information up-sampling process;

FIG. 8 schematically illustrates a possible process to simplify the motion information inheriting by performing a remapping of the existing motion information in the base layer;

FIG. 9 shows the main elements of a scalable video encoder implementing the teachings of the invention;

FIG. 10 shows the main elements of a scalable video decoder implementing the teachings of the invention;

FIG. 11 represents a possible process performed to generate the formatted base layer data;

FIG. 12 represents an extract of a body of a parameter set including an identifier of the formatted base layer data.

### DETAILED DESCRIPTION OF EMBODIMENTS OF THE INVENTION

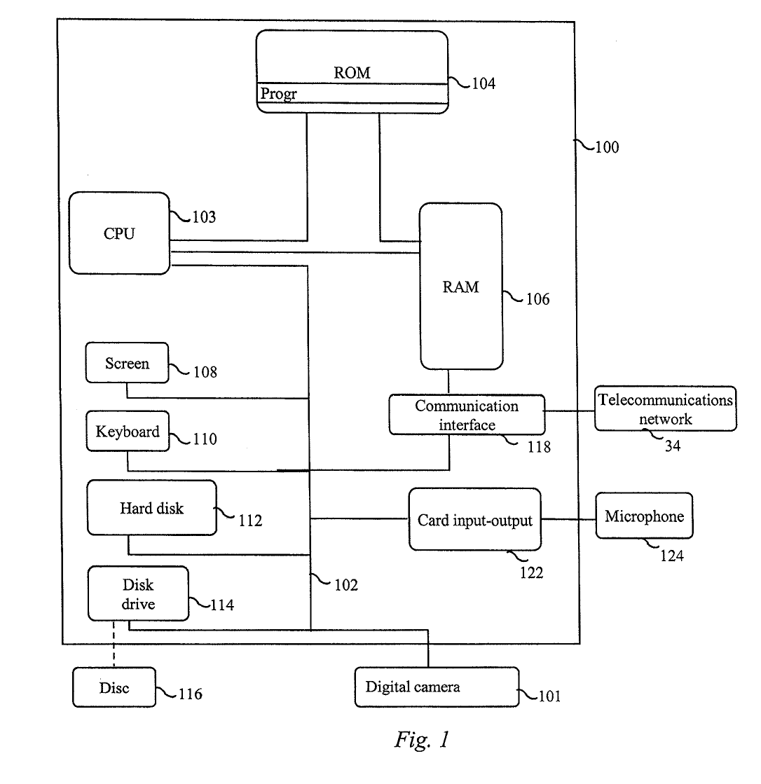

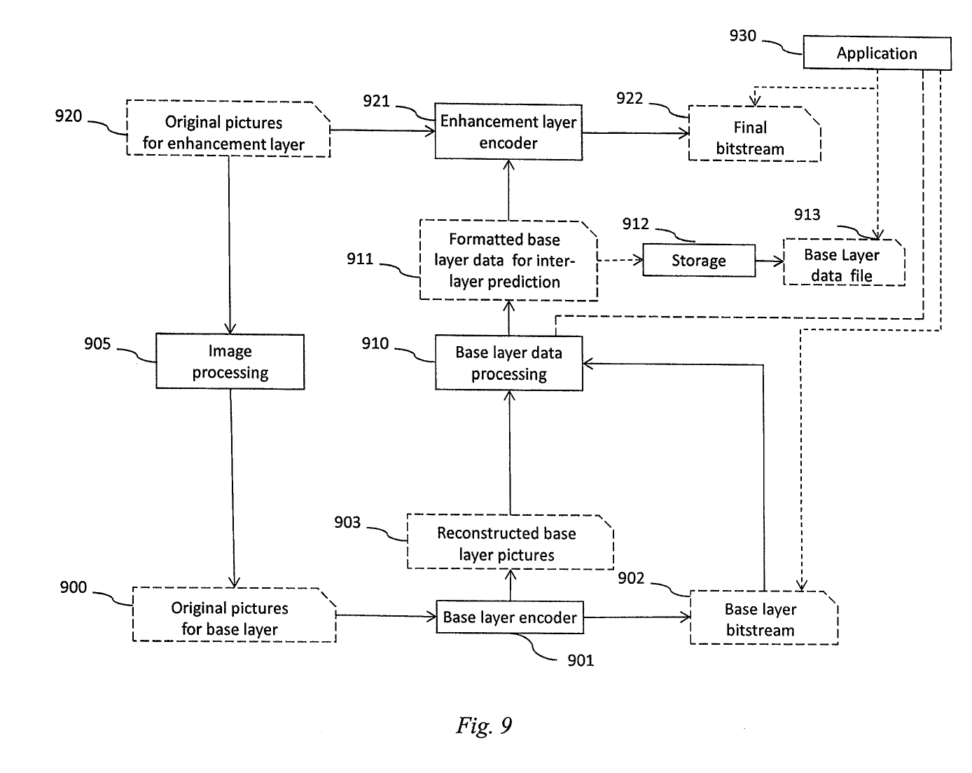

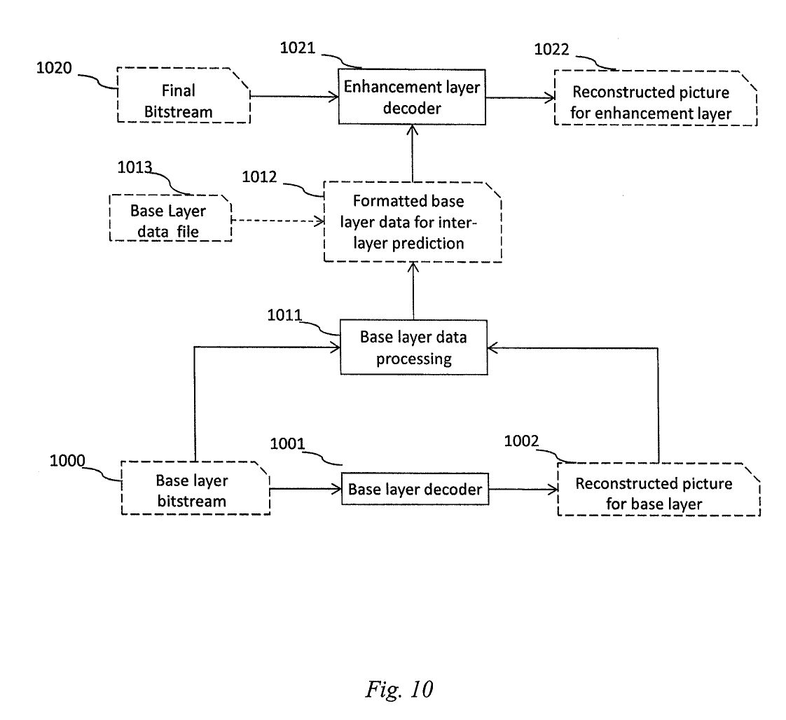

FIG. 1 illustrates an example of a device for encoding or decoding images. FIG. 1 shows a device 100, in which one or more embodiments of the invention may be implemented, illustrated in cooperation with a digital camera 101, a microphone 124 (shown via a card input/output 122), a telecommunications network 34 and a disc 116, comprising a communication bus 102 to which are connected:
a central processing CPU 103, for example provided in the form of a microprocessor;
a read only memory (ROM) 104 comprising a program 104A whose execution enables the methods according to the invention. This memory 104 may be a flash memory or EEPROM;
a random access memory (RAM) 106 which, after powering up of the device 100, contains the executable code of the program 104A necessary for the implementation of the invention, e.g. the encoding and decoding methods described with reference to FIGS. 9 and 10. This RAM memory 106, being random access type, provides fast access compared to ROM 104. In addition the RAM 106 stores the various images and the various blocks of pixels as the processing is carried out on the video sequences (transform, quantization, storage of reference images etc.);
a screen 108 for displaying data, in particular video and/or serving as a graphical interface with the user, who may thus interact with the programs according to the invention, using a keyboard 110 or any other means e.g. a mouse (not shown) or pointing device (not shown);
a hard disk 112 or a storage memory, such as a memory of compact flash type, able to contain the programs of the invention as well as data used or produced on implementation of the invention;
an optional disc drive 114, or another reader for a removable data carrier, adapted to receive disc 116 and to read/write thereon data processed, or to be processed, in accordance with the invention and;
a communication interface 118 connected to telecommunications network 34;
a connection to digital camera 101.

The communication bus 102 permits communication and interoperability between the different elements included in the device 100 or connected to it. The representation of the communication bus 102 given here is not limiting. In particular, the CPU 103 may communicate instructions to any element of the device 100 directly or by means of another element of the device 100.

The disc 116 can be replaced by any information carrier such as a Compact Disc (CDROM), either writable or rewritable, a ZIP disc or a memory card. Generally, an information storage means, which can be read by a micro-computer or microprocessor, which may optionally be integrated in the device 100 for processing a video sequence, is adapted to store one or more programs whose execution permits the implementation of the method according to the invention.

The executable code enabling the coding device to implement the invention may be stored in ROM 104, on the hard disc 112 or on a removable digital medium such as a disc 116.

The CPU 103 controls and directs the execution of the instructions or portions of software code of the program or programs of the invention, the instructions or portions of software code being stored in one of the aforementioned storage means. On powering up of the device 100, the program or programs stored in non-volatile memory, e.g. hard disc 112 or ROM 104, are transferred into the RAM 106, which then contains the executable code of the program or programs of the invention, as well as registers for storing the variables and parameters necessary for implementation of the invention. It should be noted that the device implementing the invention, or incorporating it, may be implemented in the form of a programmed apparatus. For example, such a device may then contain the code of the computer program or programs in a fixed form in an application specific integrated circuit (ASIC). The device 100 described here and, particularly the CPU 103, may implement all or part of the processing operations described below.

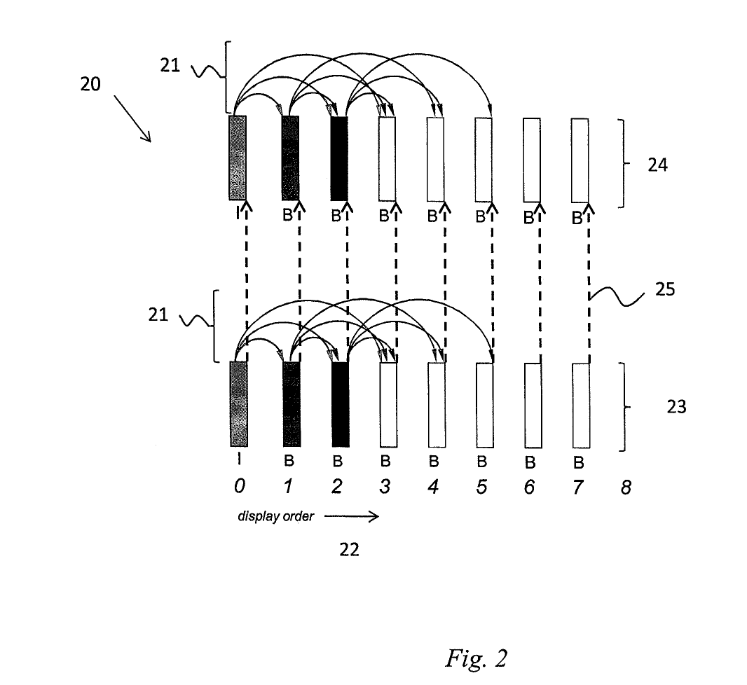

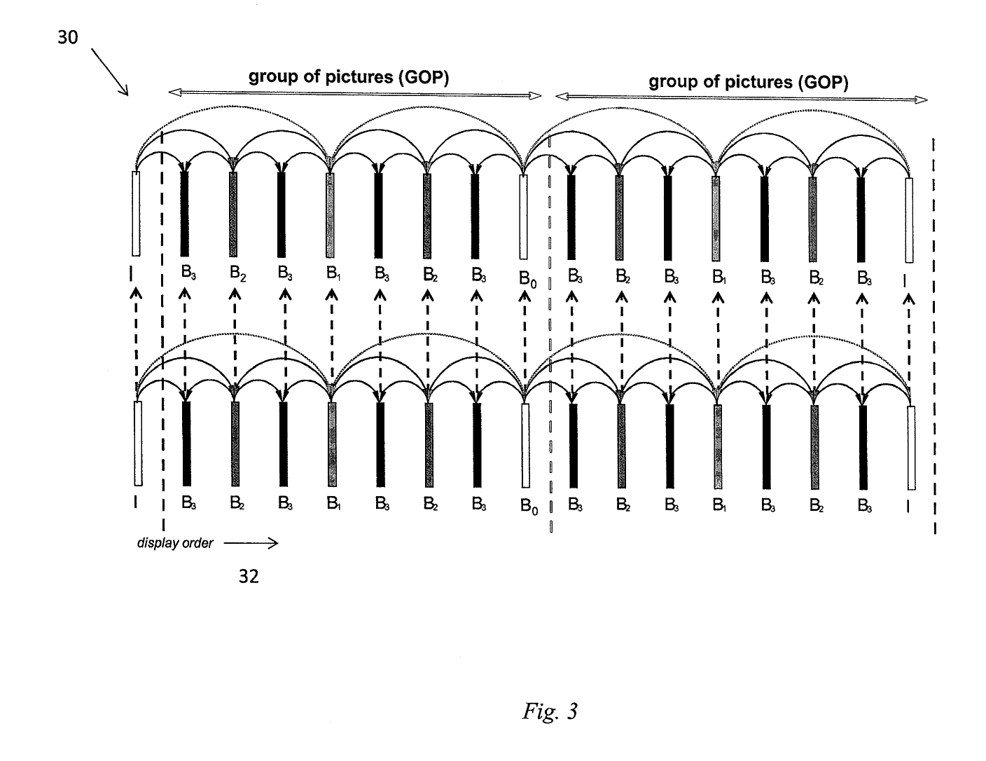

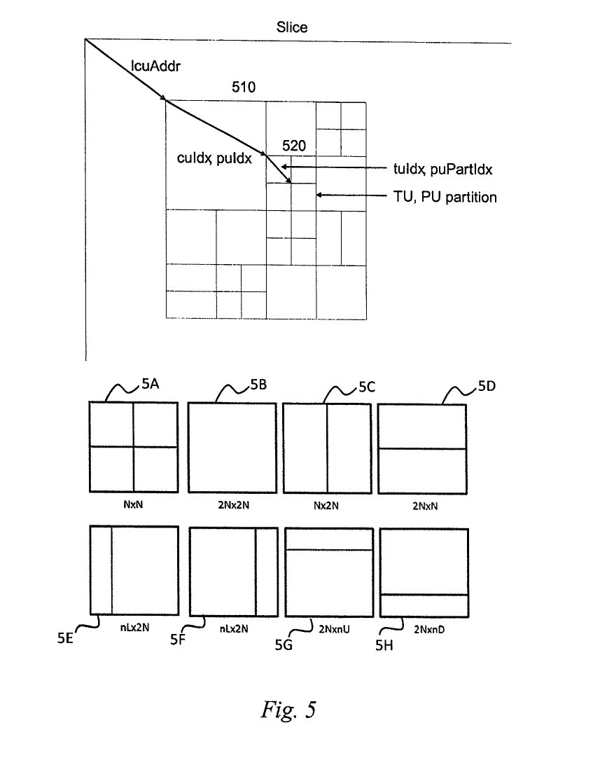

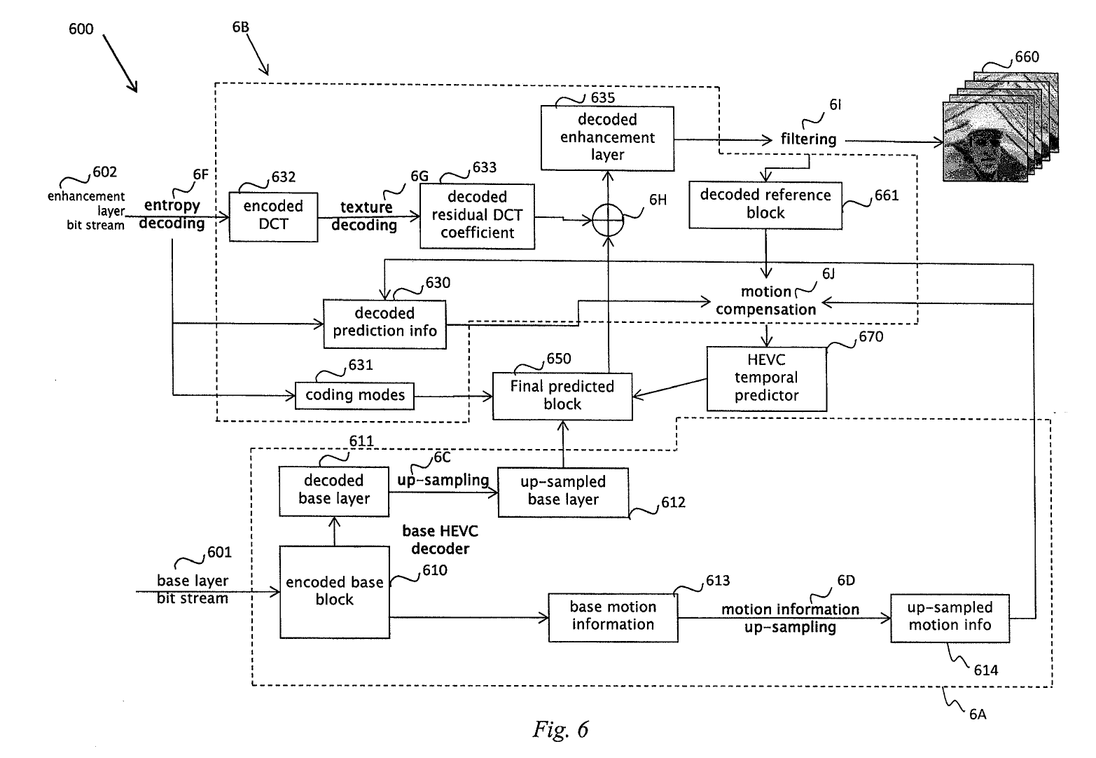

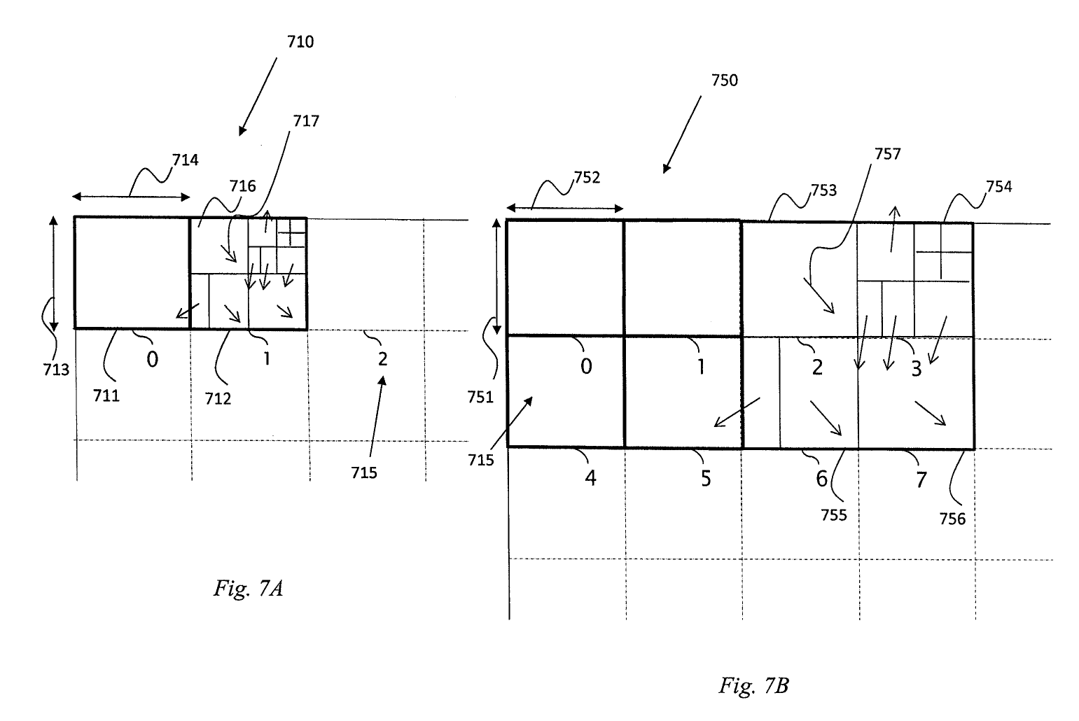

In the context described above with reference to FIGS. 2-8, the invention proposes to build a generic format to represent the base layer data that will be used for interlayer prediction to build the enhancement layer.

FIG. 9 shows the main elements of a scalable video encoder implementing the teachings of the invention.

The encoder of the base layer may be of any form like MPEG2, H.264 or any video codec. This video encoder is represented by reference 901. This encoder uses an original picture 900 for the base layer as an input and generates a base layer bitstream 902. In case of spatial scalability where a ratio of 1.5 or 2.0 is applied, the original pictures 900 for the base layer are obtained by applying a down-sampling operation (represented as step 905) to the original pictures 920 (which will be used as such for the enhancement layer as described below. The proposed video encoder also contains a decoder part, such that the base layer encoder is able to produce reconstructed base layer pictures 903.

The reconstructed base layer picture 903 and the base layer bitstream 902 are used as inputs to a base layer data processing module 910. This base layer data processing module 910 apply specific processing steps (as further described below) to modify the reconstructed base layer pictures 903 into base layer data 911 organized in a particular format. This format will be understandable and easy to use for the enhancement layer encoder for interlayer prediction purpose.

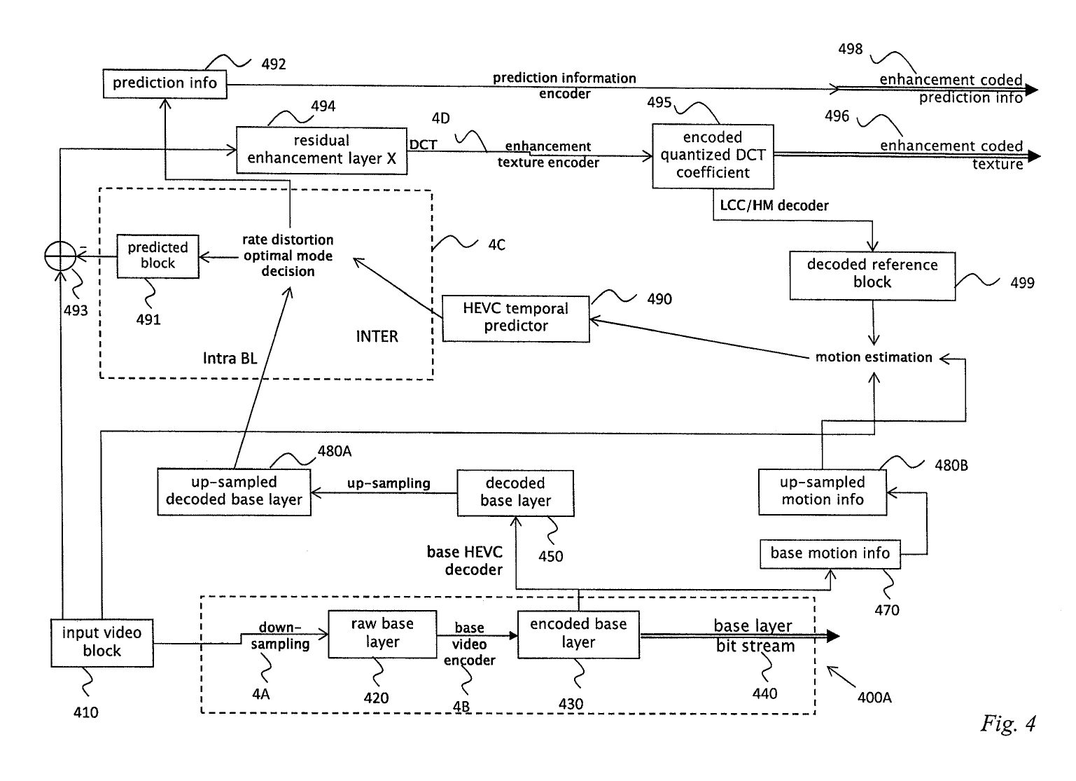

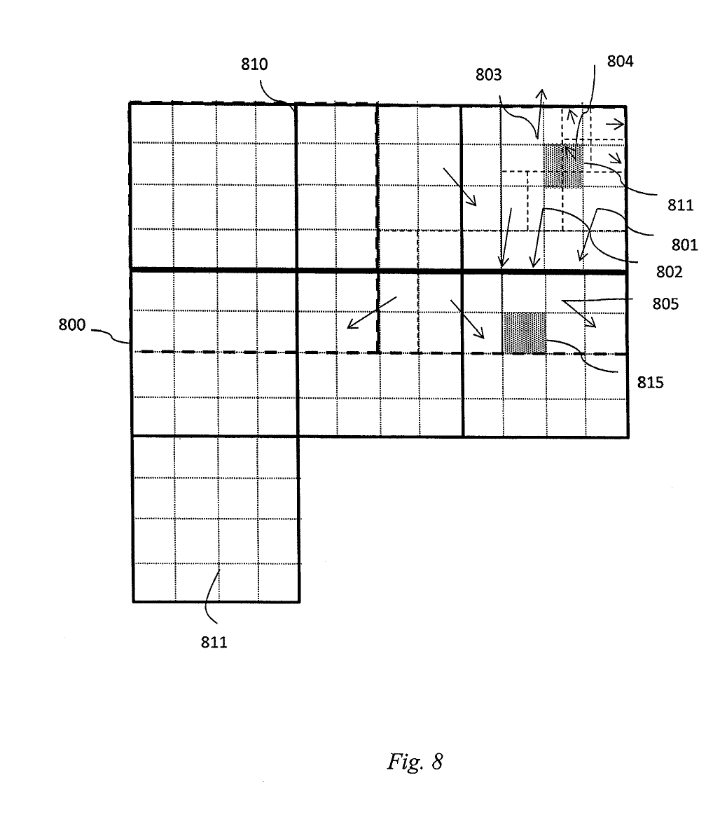

An HEVC encoder may for instance be used for the enhancement layer (referenced 921 in FIG. 9); the interlayer data can be the interlayer prediction information set forth above in connection with the description of FIG. 8, presented in a particular form. Interlayer prediction information is not limited to motion information but may also include data available in INTRA modes and parameters used for the base layer. The enhancement layer encoder 921 encodes the original pictures of the enhancement layer 920 by taking into account the formatted base layer information 911 to select the best coding mode, in a manner corresponding to what was described with reference to FIG. 4 (see “rate distortion optimal mode decision”). The modes will be those typically used in a scalable encoder where intra-layer modes and inter-layer modes (as presented above) are selected on a block basis depending on a rate-distortion criterion.

The enhancement layer encoder 921 will produce the final bitstream 922. Several options are possible for the final bitstreams.

According to a first option, the base layer bitstream may be included with the bitstream carrying the enhancement layer into the final bitstream, to obtain a single compressed file representing the two layers; according to a possible embodiment (within this first option), the bitstream can also comprise some (additional) base layer data 911 for improving the decoding of the enhancement layer, as further explained below.

According to a second option, the enhancement layer bitstream may correspond to the final bitstream 922. In that case the base layer and the enhancement layer are not merged together; according to a first possible embodiment, two bitstreams can be generated, respectively one for the enhancement layer and one for the base layer; according to a second possible embodiment, one bitstream 922 can be generated for the enhancement layer, and an additional base layer data file 913 containing the formatted base layer data 911 may then be used as explained below.

The choice among these different options is made according to a selection criterion. It can be made for instance according to an application 930 used for the decoding and communicating with the encoder (for instance during a negotiation step where parameters to be used for encoding, including the above mentioned choice, is determined based on environment parameters, such as for instance the available bandwidth or characteristics of the device incorporating the decoder). More precisely, the application 930 determines whether the base layer 902 or formatted base layer data 911 should be used during the decoding process done by the decoder (the “inter-layer processing”). For instance, if the decoder only decodes the enhancement layer, the encoder can produce only one bitstream for the enhancement layer and a base layer data file which can be used for the decoding of the enhancement layer. The base layer data file being in some embodiments less important than a complete base layer in terms of data quantity, it could be an advantage to transmit the base layer data file instead of the whole base layer.

The proposed base layer information 911 could be stored (and possible transmitted) under a standardized file format as represented by box 913, that any encoder or post processing module would comply with. This is a mandatory step in order to produce an interlayer data information file that could be used by an HEVC encoder to create the enhancement layer.

This is particularly true if the inter layer data information 911 is compact and is of a smaller size than the base layer bitstream. This is for instance the case when a summarization process (as described below) is applied to significantly reduce the size of the base layer data.

As already mentioned, the base layer data organized in the well-chosen format could be included in the final bitstream 922 or sent in a separate way in replacement of the base layer bitstream 902, in particular if the decoder is supposed to decode only the enhancement layer.

It is proposed that a syntax element be added into the bitstream 922 in order to signal the format and the processing that has been done, and possibly that needs to be done at the decoder, to generate the base layer data format 911 for inter layer prediction. This syntax element could be a format index representative of one format among a predefined set. This syntax element or index could be signalled in a general header of the bitstream like the Sequence Parameter Set (SPS) or the Picture Parameter Set (PPS). As a possible variation, to get a more adaptive change, the format used could be decided at the slice level (i.e. change from slice to slice) and thus includes this index representative of the concerned format in the Slice header.

FIG. 10 shows the main elements of a scalable video decoder implementing the teachings of the invention. This figure is the reciprocal scheme compared to the previous figure.

The decoder of the base layer 1001 decodes the base layer bitstream 1000. The decoder 1001 is of the same type as the encoder 901 (i.e. decoder 1001 and encoder 901 use the same encoding scheme) so that it can reconstruct the base layer picture 1002.

In such an embodiment where a base layer bitstream is received at the decoder, a module 1011 processes the base layer data to create generic (formatted) base layer information 1012 that can be interpreted by the enhancement layer decoder 1021, in a manner corresponding to the base layer data processing 910 performed at the encoder side. Thanks to the syntax element representative of the format included in the final bitstream 1020, the decoder 1021 knows the format and the content of the data 1012 representative of the base layer. Then depending on the coding mode associated to each block, the enhancement layer video decoder 1021 decodes the bitstream 1020, using the interlayer prediction data when needed to produce the reconstructed picture of the enhancement layer 1022.

As previously mentioned, according to a possible variation, the formatted base layer data is stored in a file 1013 (to be received from the decoder) and corresponds to the formatted base layer data 1012 to be used by the enhancement layer decoder for inter-layer prediction. This formatted base layer data 1012 is then used by the enhancement layer decoder 1021 in addition to the final bitstream 1020, which contains the complementary enhancement compressed data, for performing the entire enhancement layer decoding.

The following figures will explain how to produce the base layer data organized into the well-chosen format (represented under reference 911 in FIG. 9 and under reference 1012 in FIG. 10).

In a first embodiment, the base layer is processed by a MPEG 2 encoder/decoder and the enhancement encoder is an HEVC like encoder/decoder. The MPEG-2 compression system is much simpler that the current HEVC design and inter-layer information will be not at the same granularity of the HEVC design. For example, the MPEG2 system can provide the following information for the interlayer prediction:

1. Prediction mode: Intra, Inter or Skip;

2. Merge information: not available in MPEG2;

3. Intra prediction direction: in MPEG2, Intra blocks are coded without any intra direction prediction mode. Only DC value (i.e. pixel value) is predicted;

4. Residual data: are signaled with the variable pattern_code[i] (indicating the presence of residual data for the current block i);

5. CU size: By definition in MPEG-2, the size of the elementary unit is a fixed 8×8 blocks of pixels;

6. QP value: a QP value is associated to each 8×8 block;

7. Partition information: no partition information since partition is fixed in MPEG-2;

8. Motion vector prediction information: there is no motion prediction scheme in MPEG-2;

9. Inter direction: there are two modes in MPEG2: the P and B frames;

10. Reference picture indices: only the previous picture for P frames is used. For B frames, the previous and the next picture are used;

11. Motion vector value: up two motions vectors per 16×16 macro blocks

12. Motion vector accuracy: the motion estimation is performed with an accuracy of half-pixel.

We can see that, using MPEG-2 as the format for formatted base layer data, some information is missing or the granularity of the information is less dense compared to the current HEVC specifications. For example, the motion vector field is represented on a 16×16 block basis. As will be further explained below, several versions of base layer information (related to MPEG-2) may be included in the inter-layer data format represented by the box 911 in FIG. 9 or by the box 1012 in FIG. 10. This is further detailed in section 4.14.

In a second embodiment, the base layer is processed by a H.264 encoder/decoder system. In that case, the information that we can inherit from the base layer is more complete compared to the previous MPEG-2 system (first embodiment just mentioned). If we focus again of the general list of elements for H.264, we can have the following information.

1. Prediction mode: Intra, Inter or Skip;

2. Merge information: not available in H.264;

3. Intra prediction direction: spatial prediction from the edges of neighbouring blocks for Intra coding;

4. Residual data: are signalled through the syntax element called the coded_block pattern. This syntax element specifies in the four 8×8 Luma blocks and associated Chroma blocks of a 16×16 macro block may contain non-zero transform coefficient;

5. CU size: By definition in H264, the size of the elementary unit is a fixed 8×8 blocks of pixels;

6. QP value: a QP value is associated to each 8×8 block;

7. Partition information: Motion information partition: In H264, the 16×16 macro block can be divided up to 16 blocks of size 4×4;

8. Motion vector prediction information: the motion prediction scheme in H264 is using the median vector;

9. Inter direction: there are two modes in H264: the P and B frames;

10. Reference picture indices: only the previous picture for P frames is used. For B frames, the previous and the next picture are used;

11. Motion vector value: up two motions vectors per 4×4 blocks;

12. Motion vector accuracy: the motion estimation is performed with an accuracy of ¼ pixel.

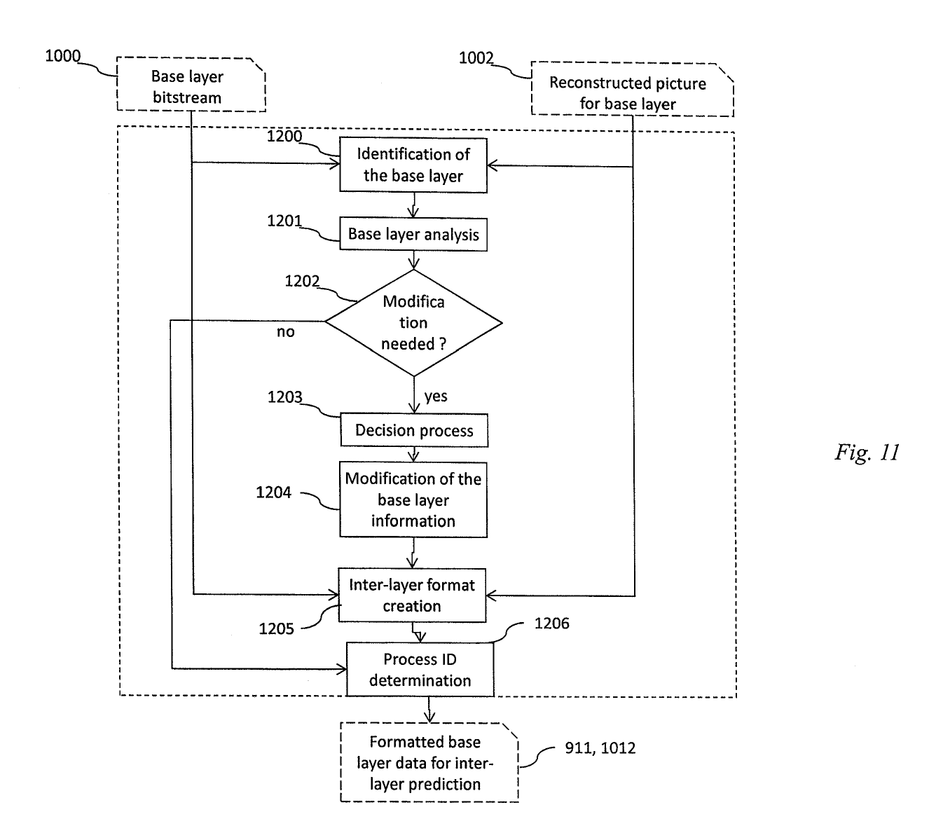

FIG. 11 represents a typical process that could be performed to generate the formatted base layer data that will be used for inter-layer prediction.

In a first step 1200, the base layer codec is identified to know the format of the video codec used in the base layer. This video codec can be of any type: MPEG2, H.264 or any commercial video codec. Then a module 1201 performs a short analysis of the base layer to determine if the raw data information coming from the base layer needs some re-formatting and modification processes. This is for instance the case if the base layer is not rich enough. Based on this analysis, a decision is taken during at step 1202.

If the modification is judged unnecessary, the inter layer data available is not modified and the next step is step 1206 described below.

This is for instance the case when the interlayer information is based on a regular representation as for the MPEG-2 where the motion information is associated to 16×16 macro-block and the residual information is represented at the granularity of 8×8 blocks. The reconstructed pixel generated by the MPEG-2 decoder may thus be used after up-sampling for the Intra_BL mode and all the information from the base layer can be used without any modification.

This is also the case when the interlayer information is based on the H.264 specifications, where up to 2 vectors can be coded for the up to 16 4×4 blocks in the macro blocks. The reconstructed pixel generated by the H.264 decoder may thus be used for the Intra_BL mode.

Otherwise, if the answer is positive in step 1202 (i.e. when a modification of the base layer data is needed to obtain the formatted base layer information or inter layer data), a further decision process is performed at step 1203 to know which modification process should be performed. This process is then followed by the step 1204 where the decided modification of the inter layer data is carried out. More specifically, several modifications can be performed in that step and are described in the next paragraph. The resulting interlayer data 1205 can be used on the fly when the encoder of the base layer and the encoder of the enhancement layer are running simultaneously. The processing described in that figure may also be done without encoding the enhancement layer. In that case, the inter-layer data is stored in a file.

In one possible embodiment for the modification just mentioned and in order to improve the coding efficiency for the enhancement layer, the inter-layer information may be enriched to get a finer representation of the base layer. For example, an 8×8 representation of the motion information may be built from the original representation based on a 16×16 macro-block. To reach this finer motion representation in the base layer, a mechanism of motion interpolation between blocks is performed. This interpolation can be based on filtering the motion vector values. This filtering operation can be done by a linear filter (like a bilinear filter or any other filters) on neighbouring motion vectors, or by using a non-linear filter like a median filter. This enables to generate a denser motion vector field for the formatted base layer information that will be useful for the enhancement layer.

In another possible embodiment for the modification, the base data information may be summarized for use as the interlayer data representation. This may be done to reach a good compromise between the coding efficiency of the enhancement layer and the needed information in the base layer. For example, in H264, the motion information can be considered as too dense and useless for interlayer prediction. In that case, a summarization process could be applied to reduce the motion data information. The motion data information can be reduced in several ways:
The first way is to reduce the number of motion vectors per block. Instead of having a bi-directional motion vector per block, we can imagine to have only one motion vector per block. For example, the selection of the single motion vector is performed by retaining the motion vector of the closest reference frame.
The second way is to reduce the accuracy of the motion vector per block. For example, all motion vectors with a ¼ precision of a base layer using H.264 could be converted to a ½ precision.
A third way to reduce the motion information is to limit the number of lists for the reference frames. This limitation enables to indicate for example only one single list. In that case, there is no need to indicate the reference list per block and therefore this information is not represented in the formatted base layer data 1012.
A fourth way is to limit the number of reference frames per list. In that case, the index of the reference frame can be represented on fewer bits. In the case where only one image is stored in a list, no index is needed since the list is unique.

In a further embodiment for the modification, the base data information is modified for the interlayer data representation without specifically seeking to change the volume of the data. For example, the reconstructed pixel of the base layer used for the Intra_BL mode is pre-processed. A filtering operation could be performed on the reconstructed pixels. For example, it includes a filtering process like a Sample Adaptive Offset filtering, a Deblocking filter or an Adaptive Loop filtering. It can also include the reduction of the bit depth of the reconstructed picture. For example, if the base layer is represented on 10 bits, we can imagine a reduction to 8 bits for interlayer prediction of the samples.
In yet a further embodiment, some or all the previous steps of reduction, expansion or modification of the base layer data may be combined to provide the inter layer data information (i.e. the formatted base layer information used for inter layer prediction). For example, the reconstructed picture is filtered by a filtering process and the motion information accuracy is reduced to a ½ pixel precision.

Then when step 1205 is performed or there is no modification needed on the base layer information (negative answer at step 1202), the process continues at step 1206 where a processing identification number is attached to the (possibly modified) base layer information. This identification number is adapted to finely determine the process to be performed then by the decoder.

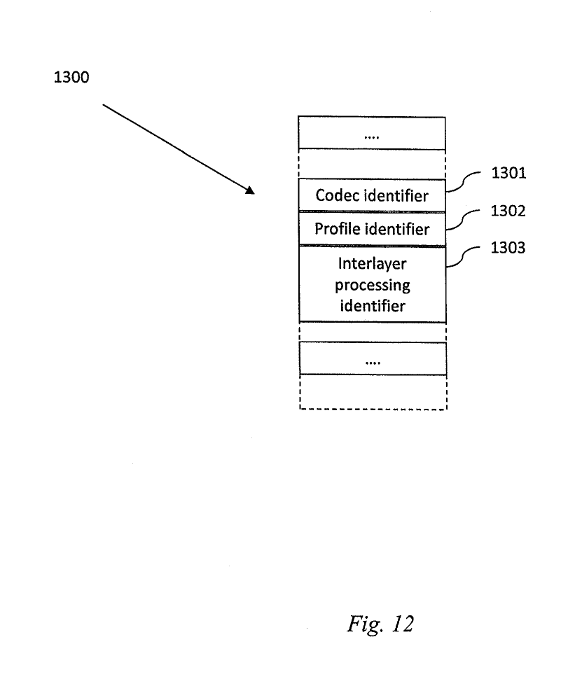

FIG. 12 is an example of the identifier item (or identification number) that could be included in the bitstream. More specifically, this figure represents an extract of a body of a parameter set 1300 like the Sequence Parameter Set, the Picture Parameter Set or the Slice header.

In the present example, the identifier item includes three distinct identifiers. The first identifier 1301 is a syntax element representative of the codec used for the base layer. The second identifier 1302 is a profile identifier enabling to characterize the different tools used inside the video codec for the base layer. The third identifier 1303 corresponds to the modification process that has been performed on the base layer to generate the interlayer data (i.e. the formatted base layer information).

In the following Table, examples are given of what could be used for the different identifiers. The codec (Codec identifier) is represented by the first column. The second column (Codec profile) of the table indicates the profile of the codec if the codec has several profiles. Finally, the third column (interlayer processing identifier) corresponds to the process identifier and will be dedicated to the different processing tasks performed on the data of the base layer.

The table allows to determine the application 930 (see FIG. 9), and consequently the bitstream(s) and/or files which need to be produced.

| Base layer | | | |
|---|---|---|---|
| codec | Profile | Interlayer processing | Interlayer processing |
| identifier | identifier | identifier | description |
| MPEG2 | Main | MPEG2 | No modification |
| | Profile | | |
| | (MP) | | |
| MPEG2 | Constrained | MPEG2_mv_8x8 | Expansion of the motion |
| | Baseline | | vector on a regular |
| | Profile (CBP) | | representation where |
| | | | motion vector are |
| | | | represented on 8x8 block |
| | | | basis. |
| MPEG2 | Constrained | MPEG2_no_residual | The residual data of |
| | Baseline | | MPEG2 8x8 block will |
| | Profile (CBP) | | not be used for the |
| | | | residual prediction |
| H.264 | Baseline | H.264 | No modification of the |
| | Profile (BP) | | base layer data |
| H.264 | Baseline | H.264_1/2 | Reduction of the base |
| | Profile (BP) | | layer precision |
| H.264 | Main Profile | H.264_single_liste | Only one list is considered |
| | (MP) | | |
| H.264 | Main Profile | H.264_one_ref | Only one reference frame |
| | (MP) | | is considered. |
| H.264 | Main Profile | H.264_no_residual | The base layer data does |
| | (MP) | | not contain any residual. |

The above examples are merely possible embodiments of the invention, which is not limited thereby.

1. A method for encoding an image comprising the following steps:
obtaining intermediate data representative of a base layer of said image encoded in a first compression format, the intermediate data being encoded according to a predefined data format allowing inter layer prediction of an enhancement layer of said image to be encoded in any of a plurality of second compression formats;
generating a final bitstream by encoding the enhancement layer according to one of said second compression formats.

2. The method according to claim 1, wherein said final bitstream possibly includes, depending on a selection criterion, data of the base layer or said intermediate data.

3. The method according to claim 1, wherein data of the enhancement layer is determined by:
determining a predicted enhancement image based on said intermediate data;
subtracting the predicted enhancement image from a raw version of the image to obtain residual data;
encoding the residual data.

4. The method according to claim 1, wherein said intermediate data is obtained from base layer data through a filtering process or is obtained from base layer data through a summarization process.

5. A method according to claim 1, wherein said intermediate data is obtained from base layer data through a summarization process is wherein the summarization process involves a reduction of a motion vector number per block of pixels in the image or involves a reduction in accuracy of motion vector values or involves a reduction of a reference image list number or involves a reduction of a number of reference images per reference image list.

6. A method according to claim 1, comprising a step of generating an identifier descriptive of said predefined data format.

7. The method according to claim 6, wherein said identifier is included in a parameter set or is included in a slice header.

8. The method according to claim 6, wherein said identifier includes a syntax element representative of the codec used in said predefined data format or includes a profile identifier defining at least one tool used said predefined data format or includes an element indicative of a process applied to data of the base layer to obtain the intermediate data.

9. A method for decoding an image comprising the following steps:
receiving a final bitstream comprising an enhancement layer encoded in one of a plurality of second compression formats;
receiving an identifier descriptive of a predefined format;
obtaining intermediate data representative of a base layer of said image encoded in a first compression format, the intermediate data being encoded according to said predefined data format allowing inter layer prediction of an enhancement layer of said image in any of said plurality of second compression formats.

10. The method according to claim 9, wherein the final bitstream includes data of the base layer.

11. The method according to claim 9, comprising a step of reconstructing said image by:
determining a predicted enhancement image based on said intermediate data;
decoding data of the enhancement layer to obtain residual data;
combining the predicted enhancement image and the residual data to obtain the reconstructed image.

12. The method according to claim 9, wherein said identifier is included in a parameter set or is included in a slice header.

13. The method according to claim 9, wherein said identifier includes a syntax element representative of the codec used in said predefined data format or includes a profile identifier defining at least one tool used said predefined data format or includes an element indicative of a process applied to data of the base layer to obtain the intermediate data.

14. A device for encoding an image comprising:
a module configured to obtain intermediate data representative of a base layer of said image encoded in a first compression format, the intermediate data being encoded according to a predefined data format allowing inter layer prediction of an enhancement layer of said image to be encoded in any of a plurality of second compression formats;
a module configured to generate a final bitstream by encoding the enhancement layer according to one of said second compression formats.

15. A device for decoding an image comprising:
a module configured to receive a final bitstream, comprising an enhancement layer encoded in one of a plurality of second compression formats, and an identifier descriptive of a predefined format;
a module configured to obtain intermediate data representative of a base layer of said image encoded in a first compression format, the intermediate data being encoded according to said predefined data format allowing inter layer prediction of an enhancement layer of said image in any of said plurality second compression formats.

16-30. (canceled)

31. A non-transitory computer-readable medium storing a program which, when executed by a microprocessor or computer system in a device, causes the device to perform the steps of claim 1.
